(19) United States
(12) Patent Application Publication
(10) Pub. No.: US 2020/0059939 A1
(43) Pub. Date: Feb. 20, 2020

(54) CROSS-CARRIER SCHEDULING FOR BANDWIDTH PARTS

(71) Applicant: QUALCOMM Incorporated, San Diego, CA (US)

(72) Inventors: Heechoon LEE, San Diego, CA (US); Jing SUN, San Diego, CA (US); Peter GAAL, San Diego, CA (US); Peter Pui Lok ANG, San Diego, CA (US); Huilin XU, San Diego, CA (US)

(21) Appl. No.: 16/543,040

(22) Filed: Aug. 16, 2019

Related U.S. Application Data
(60) Provisional application No. 62/764,996, filed on Aug. 20, 2018.

(51) Int. Cl. H04W 72/12

(52) U.S. Cl. CPC H04W 72/12

(57) ABSTRACT

Various aspects of the present disclosure generally relate to wireless communication. In some aspects, a user equipment (UE) may select a search space configuration for a scheduled cell of the UE based at least in part on one or more active bandwidth parts of the UE, wherein the UE is associated with a scheduling cell, and wherein the one or more active bandwidth parts are associated with at least one of one or more first bandwidth part configurations of the scheduling cell or one or more second bandwidth part configurations of the scheduled cell; and receive information based at least in part on the search space configuration. Numerous other aspects are provided.

### CROSS-REFERENCE TO RELATED APPLICATIONS

This application claims priority to Provisional Patent Application No. 62/764,996, filed on Aug. 20, 2018, entitled “CROSS-CARRIER SCHEDULING FOR BANDWIDTH PARTS,” which is hereby expressly incorporated by reference herein.

### FIELD OF THE DISCLOSURE

Aspects of the present disclosure generally relate to wireless communication, and to techniques and apparatuses for cross-carrier scheduling for bandwidth parts (BWPs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, etc.). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method for wireless communication, performed by a user equipment (UE), may include selecting a search space configuration for a scheduled cell of the UE based at least in part on one or more active bandwidth parts of the UE, wherein the UE is associated with a scheduling cell, and wherein the one or more active bandwidth parts are associated with at least one of one or more first bandwidth part configurations of the scheduling cell or one or more second bandwidth part configurations of the scheduled cell; and receiving information based at least in part on the search space configuration.

In some aspects, a UE for wireless communication may include memory and one or more processors, operatively coupled to the memory, configured to select a search space configuration for a scheduled cell of the UE based at least in part on one or more active bandwidth parts of the UE, wherein the UE is associated with a scheduling cell, and wherein the one or more active bandwidth parts are associated with at least one of one or more first bandwidth part configurations of the scheduling cell or one or more second bandwidth part configurations of the scheduled cell; and receive information based at least in part on the search space configuration.

In some aspects, a non-transitory computer-readable medium may store one or more instructions for wireless communication. The one or more instructions, when executed by one or more processors of a UE, may cause the one or more processors to select a search space configuration for a scheduled cell of the UE based at least in part on one or more active bandwidth parts of the UE, wherein the UE is associated with a scheduling cell, and wherein the one or more active bandwidth parts are associated with at least one of one or more first bandwidth part configurations of the scheduling cell or one or more second bandwidth part configurations of the scheduled cell; and receive information based at least in part on the search space configuration.

In some aspects, an apparatus for wireless communication may include means for selecting a search space configuration for a scheduled cell of the apparatus based at least in part on one or more active bandwidth parts of the apparatus, wherein the apparatus is associated with a scheduling cell, and wherein the one or more active bandwidth parts are associated with at least one of one or more first bandwidth part configurations of the scheduling cell or one or more second bandwidth part configurations of the scheduled cell; and means for receiving information based at least in part on the search space configuration.

Aspects generally include a method, apparatus, system, computer program product, non-transitory computer-readable medium, user equipment, base station, wireless communication device, and processing system as substantially described with reference to and as illustrated by the specification and drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a user equipment (UE) in a wireless communication network, in accordance with various aspects of the present disclosure.

FIG. 3 is a diagram illustrating an example of cross carrier scheduling with multiple BWP configurations, in accordance with various aspects of the present disclosure.

FIG. 4 is a diagram illustrating an example of determination of a search space configuration for cross carrier scheduling and BWP switching, in accordance with various aspects of the present disclosure.

FIG. 5 is a diagram illustrating an example process performed, for example, by a user equipment, in accordance with various aspects of the present disclosure.

### DETAILED DESCRIPTION

In New Radio (NR), a bandwidth part (BWP) has been introduced. Multiple BWPs may be configured for a component carrier (CC) using different BWP configurations. A single active BWP may be permitted in the uplink and the downlink per CC, as of Release 15 of the 3GPP standard. The BWP may be switched or reconfigured from one BWP configuration to another BWP configuration. Cross-carrier scheduling may be supported. A search space for a UE may be configured per BWP configuration, and an associated control resource set (CORESET) may correspond to the bandwidth part. For example, each BWP configuration may be associated with a respective search space configuration corresponding to a CORESET within each BWP configuration. Whe a CC switches the active BWP from one BWP configuration to another BWP configuration, the CC may use the target BWP configuration to determine the search space configuration for the CC.

There may be some uncertainty when cross-carrier scheduling is used in connection with BWP switching. For example, assume that a CC 0 is used to schedule traffic for the CC 0 and a CC 1 of a UE. In this case, CC 0 may be said to be self-carrier scheduled, and may be referred to as a scheduling cell. CC 1 may be said to be cross-carrier scheduled, and may be referred to as a scheduled cell. From the perspective of CC 1, it is unclear whether the search space configuration associated with an active BWP of CC 0 (e.g., the scheduling cell) or the search space configuration associated with an active BWP of CC 1 (e.g., the scheduled cell) should be used to determine the search space for CC 1.

Some techniques and apparatuses described herein provide determination of a search space configuration for a scheduled cell for a UE performing carrier aggregation (CA). For example, some techniques and apparatuses described herein may use a search space configuration associated with a scheduling cell for the scheduled cell. Some techniques and apparatuses described herein may use a search space configuration associated with the scheduled cell for the scheduled cell. Some techniques and apparatuses described herein may use a search space configuration associated with a scheduling cell for some configuration information, and may use a search space configuration associated with a scheduled cell for other configuration information. In this way, ambiguity for search space determination for cross carrier scheduling with BWP switching may be reduced, thereby improving network performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

It is noted that while aspects may be described herein using terminology commonly associated with 3G and/or 4G wireless technologies, aspects of the present disclosure can be applied in other generation-based communication systems, such as 5G and later, including NR technologies.

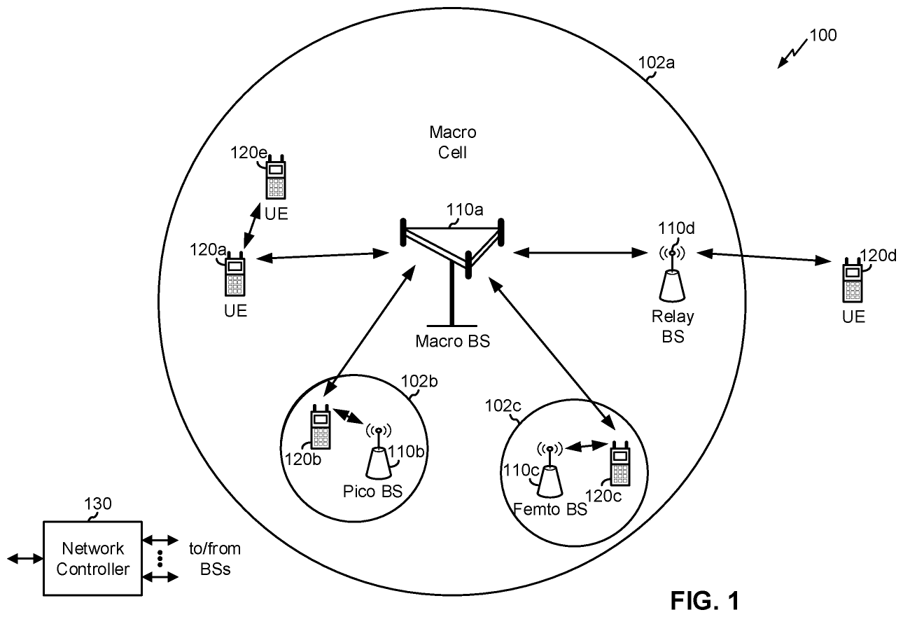

FIG. 1 is a diagram illustrating a network 100 in which aspects of the present disclosure may be practiced. The network 100 may be an LTE network or some other wireless network, such as a 5G or NR network. Wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the access network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, etc.

Wireless network 100 may be a heterogeneous network that includes BSs of different types, e.g., macro BSs, pico BSs, femto BSs, relay BSs, etc. These different types of BSs may have different transmit power levels, different coverage areas, and different impact on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, etc. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, a biometric sensor or device, a wearable device (smart watches, smart clothing, smart glasses, smart wrist bands, smart jewelry (e.g., smart ring, smart bracelet)), an entertainment device (e.g., a music or video device, or a satellite radio), a vehicular component or sensor, a smart meter or sensor, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, etc., that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs. In some cases, NR or 5G RAT networks may be deployed.

In some examples, access to the air interface may be scheduled, wherein a scheduling entity (e.g., a base station) allocates resources for communication among some or all devices and equipment within the scheduling entity's service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity.

Base stations are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided merely as an example. Other examples may differ from what is described with regard to FIG. 1.

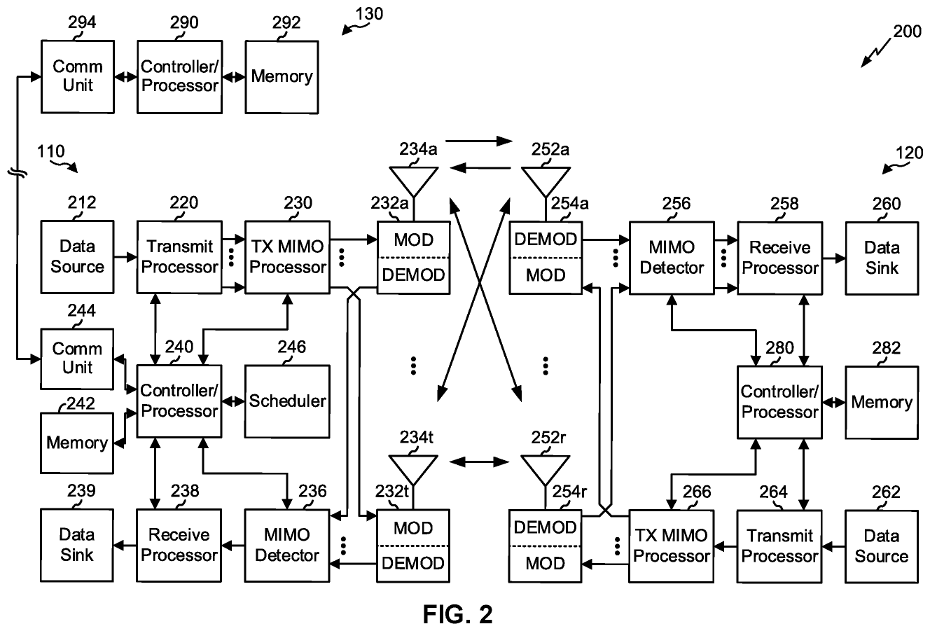

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI), etc.) and control information (e.g., CQI requests, grants, upper layer signaling, etc.) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), etc. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, etc.) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, etc.), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

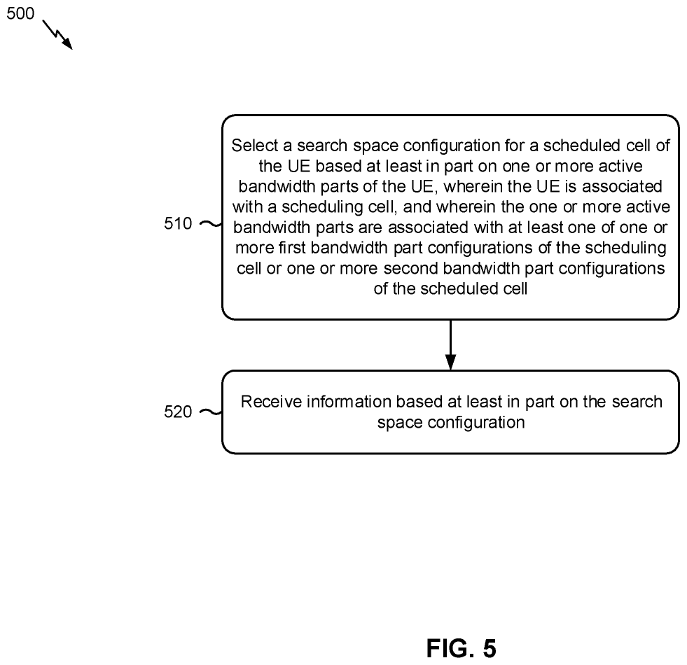

Controller/processor 240 of base station 110, controller/processor 280 of UE 120, and/or any other component(s) of FIG. 2 may perform one or more techniques associated with cross-carrier scheduling for bandwidth parts, as described in more detail elsewhere herein. For example, controller/processor 240 of base station 110, controller/processor 280 of UE 120, and/or any other component(s) of FIG. 2 may perform or direct operations of, for example, process 500 of FIG. 5 and/or other processes as described herein. Memories 242 and 282 may store data and program codes for base station 110 and UE 120, respectively. A scheduler 246 may schedule UEs for data transmission on the downlink and/or uplink.

The stored program codes, when executed by controller/processor 280 and/or other processors and modules at UE 120, may cause the UE 120 to perform operations described with respect to process 500 of FIG. 5 and/or other processes as described herein. The stored program codes, when executed by controller/processor 240 and/or other processors and modules at base station 110, may cause the base station 110 to perform operations described with respect to process 500 of FIG. 5 and/or other processes as described herein. A scheduler 246 may schedule UEs for data transmission on the downlink and/or uplink.

In some aspects, UE 120 may include means for selecting a search space configuration for a scheduled cell of the UE 120 based at least in part on one or more active bandwidth parts of the UE 120, wherein the UE 120 is associated with a scheduling cell, and wherein the one or more active bandwidth parts are associated with at least one of one or more first bandwidth part configurations of the scheduling cell or one or more second bandwidth part configurations of the scheduled cell; means for receiving information based at least in part on the search space configuration; means for determining that the one or more active bandwidth parts are not associated with the search space configuration for the scheduled cell; means for switching an active bandwidth part, of the one or more active bandwidth parts, from one of the one or more second bandwidth part configurations to another one of the one or more second bandwidth part configurations on the scheduled cell, wherein selecting the search space configuration is based at least in part on the other one of the one or more second bandwidth part configurations; and/or the like. In some aspects, such means may include one or more components of UE 120 described in connection with FIG. 2.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided merely as an example. Other examples may differ from what is described with regard to FIG. 2.

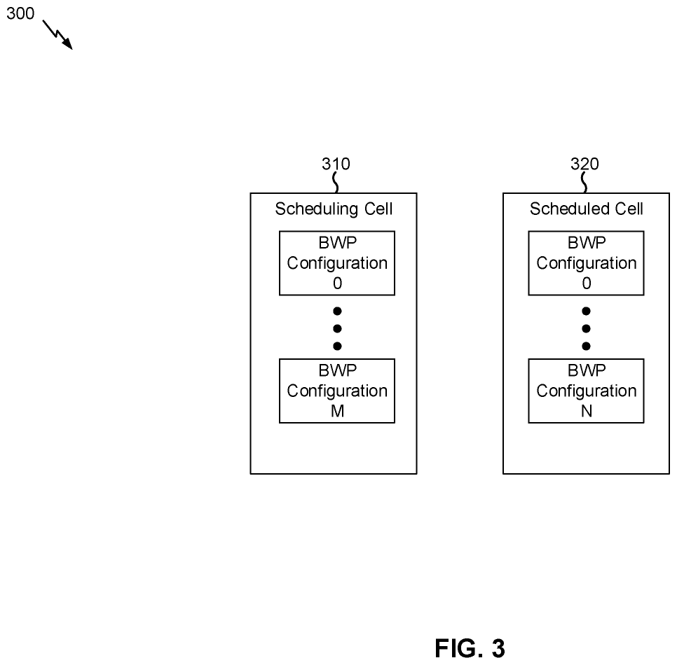

FIG. 3 is a diagram illustrating an example 300 of cross carrier scheduling with multiple BWP configurations, in accordance with various aspects of the present disclosure. FIG. 3 illustrates a configuration for a UE (e.g., UE 120) that includes a scheduling cell 310 and a scheduled cell 320.

Scheduling information for the UE 120 may be provided on the scheduling cell 310. For example, scheduling information (or other information) for both the scheduling cell 310 and the scheduled cell 320 may be provided on the scheduling cell 310.

Each cell may be associated with a respective plurality of BWP configurations. Here, the scheduling cell 310 is associated with BWP configurations 0 through M and the scheduled cell 320 is associated with BWP configurations 0 through N. M may be different from N or equal to N. The UE may be associated with one or more active BWPs. For example, an active BWP may be associated with a cell. An active BWP may use a BWP configuration for the associated cell. For example, an active BWP of the scheduling cell 310 may use one of BWP configurations 0 through M, and an active BWP of the scheduled cell 320 may use one of BWP configurations 0 through N. In some aspects, both cells may be associated with a respective active BWP. In some aspects, only the scheduling cell may be associated with an active BWP. For example, the scheduled cell may become dormant for the UE, as described in more detail elsewhere herein.

Each BWP configuration may be associated with a respective search space configuration. The search space configuration may identify a configuration for a search space (e.g., aggregation level, number of candidates, monitoring periodicity, monitoring symbols within a slot, DCI formats to monitor, associated CORESET, etc.) that the UE is to use to receive information when using the BWP configuration for an active BWP. The search space configuration may be associated with a CORESET included in the BWP configuration. In some aspects, multiple BWP configurations may be associated with a single CORESET. For example, the single CORESET may be included in multiple overlapping BWPs.

The active BWP may be switched or reconfigured. For example, the UE may switch from an active BWP associated with a first BWP configuration to an active BWP associated with a second BWP configuration. This may be based at least in part on downlink control information (DCI), radio resource configuration (RRC) information, and/or the like. Some techniques and apparatuses described herein provide determination of which search space configuration should be used for the scheduled cell 320. For example, since the BWP configuration for the active BWP of the scheduling cell 310 and the BWP configuration for the active BWP of the scheduled cell 320 may each be associated with a respective search space configuration, and since the active BWP may change in some cases, it is beneficial to use a predefined scheme for determining the appropriate search space configuration for the scheduled cell 320.

As indicated above, FIG. 3 is provided as an example. Other examples may differ from what is described with respect to FIG. 3.

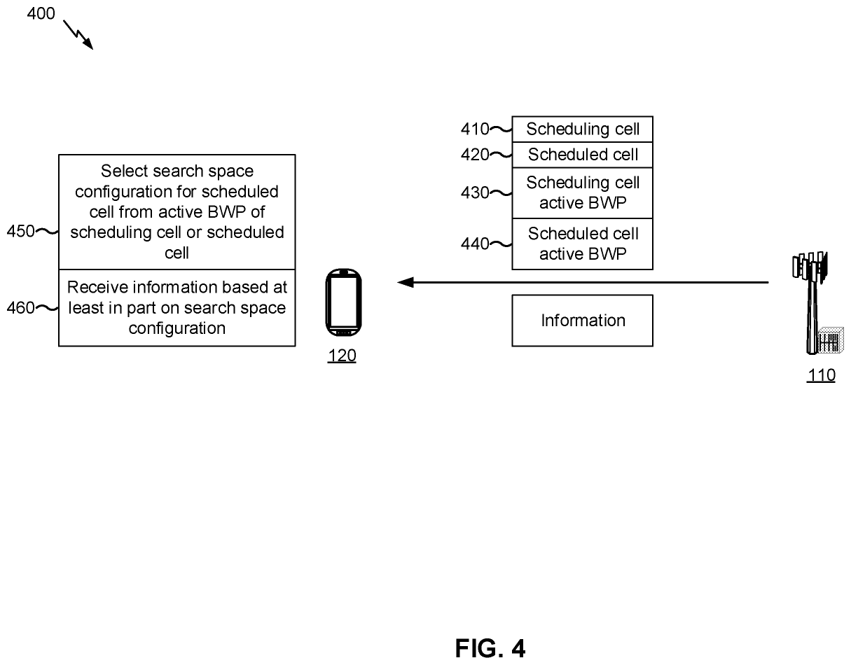

FIG. 4 is a diagram illustrating an example 400 of determination of a search space configuration for cross carrier scheduling and BWP switching, in accordance with various aspects of the present disclosure.

As shown, a BS 110 may provide a scheduling cell 410 and a scheduled cell 420 to a UE 120. In some aspects, the scheduling cell 410 and the scheduled cell 420 may be provided by different BSs 110, different transmission/reception points, different antenna panels, and/or the like. As further shown, the scheduling cell 410 may be associated with an active BWP 430 and the scheduled cell 420 may be associated with an active BWP 440. In some aspects, the active BWP 430 and the active BWP 440 may be active. In some aspects, only one of the active BWP 430 or the active BWP 440 may be active, as described in more detail elsewhere herein. The active BWPs 430 and 440 may be configured in accordance with respective BWP configurations, which may be defined in association with CORESETs of the scheduling cell 410 and the scheduled cell 420.

As shown by reference number 450, the UE 120 or the BS 110 may select a search space configuration for the scheduled cell. As further shown, in some aspects, the UE 120 may select the search space configuration based at least in part on an active BWP of the scheduling cell, as described in more detail below. In some aspects, the UE 120 may select the search space configuration based at least in part on an active BWP of the scheduled cell, as also described in more detail below. It should be understood that selecting or determining a search space configuration, as used herein, can refer to selecting or determining part of a search space configuration. For example, the UE 120 or the BS 110 may select a first part of a search space configuration based at least in part on the active BWP 430 of the scheduling cell 410, and may select a second part of a search space configuration based at least in part on the active BWP 440 of the scheduled cell 420.

In some aspects, the UE 120 or the BS 110 may determine the search space configuration based at least in part on the active BWP 430 of the scheduling cell 410. For example, the BWP configurations of the scheduling cell 410 may be associated with respective search space configurations. The UE 120 may determine the search space configuration for the scheduled cell 420 in accordance with the search space configuration corresponding to the BWP configuration used for the active BWP 430. For example, the UE 120 or the BS 110 may use the same identifier for search spaces configured in the scheduled cell 420 and the scheduling cell 410, and may ignore a CORESET identifier configured in the scheduled cell 420. In this way, the UE 120 may determine a search space configuration in accordance with the active BWP 430's BWP configuration, thereby reducing ambiguity in configuration of the search space of the UE 120.

In some aspects, the search space configuration may be independent per scheduled cell. For example, a search space configuration for the scheduling cell 410 and the search space configuration for the scheduled cell 420 may have different search space identifiers. In this way, diversity of search space configuration may be improved. In some aspects, the search space configuration may be shared between the scheduling cell 410 and the scheduled cell 420. For example, the scheduling cell 410 and the scheduled cell 420 may share a search space identifier. In this way, network resources are conserved that would otherwise be used to specify different search space configurations for the scheduling cell 410 and the scheduled cell 420. These aspects of the search space configurations (e.g., the independent configuration or the common configuration) may be applicable when the search space configuration is determined in accordance with the scheduling cell 410 and when the search space configuration is determined in accordance with the scheduled cell 420.

In the case when the search space configuration is determined in accordance with the active BWP 430, when the active BWP 430 of the scheduling cell 410 switches from a first BWP configuration to a second BWP configuration, the search space configuration for the second BWP configuration may be used for the scheduled cell 420. When the active BWP 440 of the scheduled cell 420 switches from a first BWP configuration to a second BWP configuration, the search space configuration of the scheduled cell 420 may not change, since the search space configuration is determined in accordance with the active BWP 430 of the scheduling cell 410.

In some aspects, the UE 120 or the BS 110 may determine that an active BWP 430 or an active BWP 440 is not associated with a search space configuration. In such a case, the UE 120 may not activate the active BWP 440 of the scheduled cell 420. This may be used, for example, when the active BWP 440 is to be made dormant for power conservation purposes and/or the like. In other words, for all targeted BWPs 430/440 that are to be scheduled in the scheduling cell 410, search space configurations corresponding to the BWPs of the scheduling cell may need to be configured. If a search space configuration for a targeted BWP is not configured, this may indicate that a scheduling entity (e.g., a BS 110, a gNB, etc.) is not to schedule the scheduled cell 420. Thus, from a scheduling cell perspective, only search spaces with valid CORESETs for the active BWP 430 are valid.

In some aspects, the UE 120 or the BS 110 may determine the search space configuration based at least in part on the active BWP 440 of the scheduled cell 420. For example, the BWP configurations of the scheduled cell 420 may be associated with respective search space configurations. The UE 120 or the BS 110 may determine the search space configuration for the scheduled cell 420 in accordance with the search space configuration corresponding to the BWP configuration used for the active BWP 440 of the scheduled cell 420. For example, a number of candidates of a search space set of the scheduled cell 420 may be used for a search space set of the same index on an active BWP of the scheduling cell 410. In this way, the UE 120 or the BS 110 may determine a search space configuration in accordance with the active BWP 440's BWP configuration, thereby reducing ambiguity in configuration of the search space of the UE 120. In some aspects, the same search space configuration may be used regardless of the active BWP of the scheduled cell 420, as described in more detail elsewhere herein.

In the case when the active BWP 440 of the scheduled cell 420 is used to select the search space configuration, when the active BWP 430 of the scheduling cell 410 switches or is reconfigured, then search spaces with valid CORESETs included in or associated with the new active BWP 430 may become active. In this case, the search space configuration for the search spaces with the valid CORESETs may be conveyed in the scheduled cell 420. If there is no search space with valid CORESETs for the new active BWP 430, then there may be no scheduling for the scheduled cell 420, and the scheduled cell 420 may go dormant. When the active BWP 440 of the scheduled cell 420 switches or is reconfigured, and when the active BWP 440 of the scheduled cell 420 is used to select the search space configuration, then the search space configuration may be determined in accordance with the new active BWP 440 of the scheduled cell 420.

In some aspects, the UE 120 or the BS 110 may determine a downlink control information (DCI) size or a DCI format in accordance with the scheduled cell 420. For example, when BWP switching is performed with cross-carrier scheduling, BWP-specific fields of the DCI may be determined in accordance with a bandwidth or other characteristic of the scheduled cell 420. The BWP-specific fields may include, for example, a frequency-domain resource assignment, a time-domain resource assignment, and so on.

As shown by reference number 460, the UE 120 may receive information based at least in part on the search space configuration. For example, the UE 120 may scan a search space, may decode information, may detect a preamble, and/or the like in accordance with the search space configuration. In some aspects, the BS 110 may transit information based at least in part on the search space configuration. For example, the BS 110 may transmit information in a search space, may encode information, may apply a preamble, and/or the like based at least in part on the search space configuration.

As indicated above, FIG. 4 is provided as an example. Other examples may differ from what is described with respect to FIG. 4.

FIG. 5 is a diagram illustrating an example process 500 performed, for example, by a UE, in accordance with various aspects of the present disclosure. Example process 500 is an example where a UE (e.g., UE 120) performs cross-carrier scheduling with BWPs.

As shown in FIG. 5, in some aspects, process 500 may include selecting a search space configuration for a scheduled cell of the UE based at least in part on one or more active bandwidth parts of the UE, wherein the UE is associated with a scheduling cell, and wherein the one or more active bandwidth parts are associated with at least one of one or more first bandwidth part configurations of the scheduling cell or one or more second bandwidth part configurations of the scheduled cell (block 510). For example, the UE (e.g., using controller/processor 280 and/or the like) may select a search space configuration for a scheduled cell of the UE. The UE may select the search space configuration based at least in part on one or more active BWPs of the UE. In some aspects, the UE may be associated with a scheduling cell and a scheduled cell. The one or more active BWPs may be associated with at least one of one or more first BWP configurations of the scheduling cell or one or more second BWP configurations of the scheduled cell.

As shown in FIG. 5, in some aspects, process 500 may include receiving information based at least in part on the search space configuration (block 520). For example, the UE (e.g., using antenna 252, DEMOD 254, MIMO detector 256, receive processor 258, controller/processor 280, and/or the like) may receive information based at least in part on the search space configuration. In some aspects, the UE may determine a DCI size or format in accordance with the scheduled cell. In some aspects, the UE may decode or search for information based at least in part on the search space configuration.

Process 500 may include additional aspects, such as any single aspect or any combination of aspects described below and/or in connection with one or more other processes described elsewhere herein.

In a first aspect, at least one of the one or more first bandwidth part configurations or the one or more second bandwidth part configurations are associated with respective search space configurations from which the search space configuration is to be selected. In a second aspect, alone or in combination with the first aspect, selecting the search space configuration is based at least in part on which bandwidth part configuration, of the one or more first bandwidth part configurations, is used for the one or more active bandwidth parts.

In a third aspect, alone or in combination with the first aspect and/or the second aspect, at least part of the search space configuration does not change when an active bandwidth part, of the one or more active bandwidth parts, is switched from one of the one or more second bandwidth part configurations to another one of the one or more second bandwidth part configurations. In a fourth aspect, alone or in combination with any one or more of the first through third aspects, selecting the search space configuration is based at least in part on which bandwidth part configuration, of the one or more second bandwidth part configurations, is used for the one or more active bandwidth parts.

In a fifth aspect, alone or in combination with any one or more of the first through fourth aspects, a downlink control information format or size for the scheduled cell is based at least in part on which bandwidth part configuration, of the one or more second bandwidth part configurations, is used for the one or more active bandwidth parts. In a sixth aspect, alone or in combination with any one or more of the first through fifth aspects, the UE may determine that the one or more active bandwidth parts are not associated with the search space configuration for the scheduled cell. In a seventh aspect, alone or in combination with any one or more of the first through sixth aspects, the one or more active bandwidth parts are associated with the scheduling cell. In an eighth aspect, alone or in combination with any one or more of the first through seventh aspects, the UE may switch an active bandwidth part, of the one or more active bandwidth parts, from one of the one or more second bandwidth part configurations to another one of the one or more second bandwidth part configurations on the scheduled cell, wherein selecting the search space configuration is based at least in part on the other one of the one or more second bandwidth part configurations.

In a ninth aspect, alone or in combination with any one or more of the first through eighth aspects, the search space configuration for the scheduled cell is independent of a search space configuration for the scheduling cell. In a tenth aspect, alone or in combination with any one or more of the first through ninth aspects, the search space configuration for the scheduled cell is shared with the scheduling cell.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the aspects to the precise form disclosed. Modifications and variations are possible in light of the above disclosure or may be acquired from practice of the aspects.

As used herein, the term component is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
selecting a search space configuration for a scheduled cell of the UE based at least in part on one or more active bandwidth parts of the UE, wherein the UE is associated with a scheduling cell, and wherein the one or more active bandwidth parts are associated with at least one of:
one or more first bandwidth part configurations of the scheduling cell, or
one or more second bandwidth part configurations of the scheduled cell; and
receiving information based at least in part on the search space configuration.

2. The method of claim 1, wherein at least one of the one or more first bandwidth part configurations or the one or more second bandwidth part configurations are associated with respective search space configurations from which the search space configuration is to be selected.

3. The method of claim 1, wherein selecting the search space configuration is based at least in part on which bandwidth part configuration, of the one or more first bandwidth part configurations, is used for the one or more active bandwidth parts.

4. The method of claim 1, wherein at least part of the search space configuration does not change when an active bandwidth part, of the one or more active bandwidth parts, is switched from one of the one or more second bandwidth part configurations to another one of the one or more second bandwidth part configurations.

5. The method of claim 1, wherein selecting the search space configuration is based at least in part on which bandwidth part configuration, of the one or more second bandwidth part configurations, is used for the one or more active bandwidth parts.

6. The method of claim 1, wherein a downlink control information format or size for the scheduled cell is based at least in part on which bandwidth part configuration, of the one or more second bandwidth part configurations, is used for the one or more active bandwidth parts.

7. The method of claim 1, wherein the search space configuration for the scheduled cell is independent of a search space configuration for the scheduling cell.

8. The method of claim 1, wherein the search space configuration for the scheduled cell is shared with the scheduling cell.

9. A user equipment (UE) for wireless communication, comprising:
a memory; and
one or more processors operatively coupled to the memory, the memory and the one or more processors configured to:
select a search space configuration for a scheduled cell of the UE based at least in part on one or more active bandwidth parts of the UE, wherein the UE is associated with a scheduling cell, and wherein the one or more active bandwidth parts are associated with at least one of:
one or more first bandwidth part configurations of the scheduling cell, or
one or more second bandwidth part configurations of the scheduled cell; and
receive information based at least in part on the search space configuration.

10. The UE of claim 9, wherein at least one of the one or more first bandwidth part configurations or the one or more second bandwidth part configurations are associated with respective search space configurations from which the search space configuration is to be selected.

11. The UE of claim 9, wherein selecting the search space configuration is based at least in part on which bandwidth part configuration, of the one or more first bandwidth part configurations, is used for the one or more active bandwidth parts.

12. The UE of claim 9, wherein at least part of the search space configuration does not change when an active bandwidth part, of the one or more active bandwidth parts, is switched from one of the one or more second bandwidth part configurations to another one of the one or more second bandwidth part configurations.

13. The UE of claim 9, wherein selecting the search space configuration is based at least in part on which bandwidth part configuration, of the one or more second bandwidth part configurations, is used for the one or more active bandwidth parts.

14. The UE of claim 9, wherein a downlink control information format or size for the scheduled cell is based at least in part on which bandwidth part configuration, of the one or more second bandwidth part configurations, is used for the one or more active bandwidth parts.

15. The UE of claim 9, wherein the search space configuration for the scheduled cell is independent of a search space configuration for the scheduling cell.

16. The UE of claim 9, wherein the search space configuration for the scheduled cell is shared with the scheduling cell.

17. A non-transitory computer-readable medium storing one or more instructions for wireless communication, the one or more instructions comprising:
one or more instructions that, when executed by one or more processors of a user equipment (UE), cause the one or more processors to:
select a search space configuration for a scheduled cell of the UE based at least in part on one or more active bandwidth parts of the UE, wherein the UE is associated with a scheduling cell, and wherein the one or more active bandwidth parts are associated with at least one of:
one or more first bandwidth part configurations of the scheduling cell, or
one or more second bandwidth part configurations of the scheduled cell; and
receive information based at least in part on the search space configuration.

18. The non-transitory computer-readable medium of claim 17, wherein at least one of the one or more first bandwidth part configurations or the one or more second bandwidth part configurations are associated with respective search space configurations from which the search space configuration is to be selected.

19. The non-transitory computer-readable medium of claim 17, wherein selecting the search space configuration is based at least in part on which bandwidth part configuration, of the one or more first bandwidth part configurations, is used for the one or more active bandwidth parts.

20. The non-transitory computer-readable medium of claim 17, wherein at least part of the search space configuration does not change when an active bandwidth part, of the one or more active bandwidth parts, is switched from one of the one or more second bandwidth part configurations to another one of the one or more second bandwidth part configurations.

21. The non-transitory computer-readable medium of claim 17, wherein selecting the search space configuration is based at least in part on which bandwidth part configuration, of the one or more second bandwidth part configurations, is used for the one or more active bandwidth parts.

22. The non-transitory computer-readable medium of claim 17, wherein a downlink control information format or size for the scheduled cell is based at least in part on which bandwidth part configuration, of the one or more second bandwidth part configurations, is used for the one or more active bandwidth parts.

23. The non-transitory computer-readable medium of claim 17, wherein the search space configuration for the scheduled cell is independent of a search space configuration for the scheduling cell.

24. The non-transitory computer-readable medium of claim 17, wherein the search space configuration for the scheduled cell is shared with the scheduling cell.

25. An apparatus for wireless communication, comprising:
means for selecting a search space configuration for a scheduled cell of the apparatus based at least in part on one or more active bandwidth parts of the apparatus, wherein the apparatus is associated with a scheduling cell, and wherein the one or more active bandwidth parts are associated with at least one of:
one or more first bandwidth part configurations of the scheduling cell, or
one or more second bandwidth part configurations of the scheduled cell; and
means for receiving information based at least in part on the search space configuration.

26. The apparatus of claim 25, wherein at least one of the one or more first bandwidth part configurations or the one or more second bandwidth part configurations are associated with respective search space configurations from which the search space configuration is to be selected.

27. The apparatus of claim 25, wherein selecting the search space configuration is based at least in part on which bandwidth part configuration, of the one or more first bandwidth part configurations, is used for the one or more active bandwidth parts.

28. The apparatus of claim 25, wherein at least part of the search space configuration does not change when an active bandwidth part, of the one or more active bandwidth parts, is switched from one of the one or more second bandwidth part configurations to another one of the one or more second bandwidth part configurations.

29. The apparatus of claim 25, wherein selecting the search space configuration is based at least in part on which bandwidth part configuration, of the one or more second bandwidth part configurations, is used for the one or more active bandwidth parts.

30. The apparatus of claim 25, wherein a downlink control information format or size for the scheduled cell is based at least in part on which bandwidth part configuration, of the one or more second bandwidth part configurations, is used for the one or more active bandwidth parts.
